(19) United States
(12) Patent Application Publication
(10) Pub. No.: US 2026/0197891 A1
(43) Pub. Date: Jul. 9, 2026

(54) FRAME ERROR RECOVERY FOR COORDINATED BEAMFORMING TRANSMISSION SEQUENCE

(71) Applicant: QUALCOMM Incorporated, San Diego, CA (US)

(72) Inventors: Sherief HELWA, San Diego, CA (US); Alfred ASTERJADHI, San Diego, CA (US); George CHERIAN, San Diego, CA (US); Abhishek Pramod PATIL, San Diego, CA (US); Gaurang NAIK, San Diego, CA (US); Giovanni CHISCI, San Diego, CA (US); Sanket Sanjay KALAMKAR, San Diego, CA (US); Sai Yiu Duncan HO, San Diego, CA (US)

(21) Appl. No.: 19/438,482

(22) Filed: Dec. 31, 2025

Related U.S. Application Data
(60) Provisional application No. 63/741,844, filed on Jan. 4, 2025.

(51) Int. Cl. H04W 76/18; H04B 7/06

(52) U.S. Cl. CPC H04W 76/18; H04B 7/0617

(57) ABSTRACT

Certain aspects of the present disclosure provides a method for wireless communication performable at a wireless node (e.g., an access point (AP)), generally including outputting one or more first frames during a transmit opportunity (TXOP), wherein the one or more first frames are output as part of a frame exchange in accordance with a first coordinated communication scheme involving a first basic service set (BSS) and a second BSS, detecting a failure to obtain at least one second frame that is expected to be obtained as part of the frame exchange, and performing at least one action based on the detection.

### CROSS-REFERENCE TO RELATED APPLICATION(S)

This application claims the benefit of and priority to U.S. Provisional Application No. 63/741,844, filed Jan. 4, 2025, which is hereby incorporated by reference herein.

### TECHNICAL FIELD

This disclosure relates generally to wireless communication, and more specifically, to mechanisms for recovering from errors that occur in a coordinated beamforming (CoBF) transmission sequence.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

One innovative aspect of the subject matter described in this disclosure can be implemented in a method for wireless communication at a first wireless node. The method includes outputting one or more first frames during a transmit opportunity (TXOP), wherein the one or more first frames are output as part of a frame exchange in accordance with a first coordinated communication scheme involving a first basic service set (BSS) and a second BSS; detecting a failure to obtain at least one second frame that is expected to be obtained as part of the frame exchange; and performing at least one action based on the detection.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows a hierarchical format of an example physical layer PDU (PPDU) usable for communications between a wireless AP and one or more wireless STAs.

FIGS. 4 and 5 show pictorial diagrams of example wireless communication networks, in which coordinated beamforming (CoBF) may be utilized.

FIGS. 6A, 6B, and 7 show example timing diagrams for channel state information (CSI) feedback for CoBF.

FIGS. 8, 9, and 10 show example diagrams of sounding and CSI feedback for CoBF, in accordance with aspects of the present disclosure.

FIG. 11 shows an example diagram of sounding and CSI feedback for CoBF, in accordance with aspects of the present disclosure.

FIG. 12 shows an example diagram for a CoBF measurement phase.

FIG. 13 shows an example diagram for a CoBF transmission phase.

FIG. 14 shows an example diagram for a CoBF transmission phase supporting enhanced multilink single radio (eMLSR) clients.

FIG. 15 shows an example CoBF transmission sequence.

FIGS. 16-21 show examples of frame error recovery for a CoBF transmission sequence, in accordance with aspects of the present disclosure.

FIG. 22 shows a flowchart illustrating example process performable by a wireless device or wireless node.

FIG. 23 shows a block diagram of an example wireless communication device.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

In order to address the issue of increasing bandwidth requirements that are demanded for wireless communication systems, different schemes are being developed to allow multiple user terminals to communicate with a single access point (AP) or multiple APs by sharing the channel resources while achieving high data throughputs. Multiple Input Multiple Output (MIMO) technology represents one such approach that has recently emerged as a popular technique for the next generation communication systems.

A MIMO system employs multiple (N_{T}) transmit antennas and multiple (NR) receive antennas for data transmission. A MIMO channel formed by the N_{T} transmit and N_{R} receive antennas may be decomposed into N_{S} independent channels, which are also referred to as spatial channels, where Ns≤min(NT, NR). Each of the N_{S} independent channels corresponds to a dimension. The MIMO system can provide improved performance (such as higher throughput and greater reliability) if the additional dimensionalities created by the multiple transmit and receive antennas are utilized.

In wireless networks with multiple APs and multiple user stations (STAs), concurrent transmissions may occur on multiple channels toward different STAs, both in uplink and downlink directions. Many challenges are present in such systems. For example, the AP may transmit signals using different standards. A receiver STA may be able to detect a transmission mode of the signal based on information included in a preamble of the transmission packet.

A downlink multi-user MIMO (MU-MIMO) system based on Spatial Division Multiple Access (SDMA) transmission can simultaneously serve a plurality of spatially separated STAs by applying beamforming at the AP's antenna array. Complex transmit precoding weights can be calculated by the AP based on channel state information (CSI) received from each of the supported STAs.

In a distributed MU-MIMO system, multiple APs may simultaneously serve a plurality of spatially separated STAs by coordinating beamforming by the antennas of the multiple APs. For example, in systems utilizing such coordinated beamforming (CoBF), multiple APs may coordinate transmissions to each STA in an effort to mitigate interference to each other's STAs.

In CoBF, an AP of one basic service set (BSS) may obtain channel state information (CSI) from non-AP STAs of an overlapping BSS (OBSS) in order to mitigate interference (e.g., by forming nulls) to the STA(s). This may involve cross-BSS sounding and CSI feedback from non-AP STA(s) to OBSS AP(s). Each AP may also obtain CSI from its own BSS non-AP STA(s) for forming beams to the STA(s).

In this manner, CoBF may be considered a coordinated AP scheme that aims at simultaneously using the medium in two BSSs to maximize the system throughput. CoBF attempts to exploit the participating APs' hardware capabilities (e.g., larger antenna arrays) to actively null their signals at OBSSs' clients using Tx beamforming to limit OBSS interference.

However, CoBF relies on CSI knowledge at the transmitters (APs). Each AP must know the channel estimate between itself and its own client as well as the OBSS client. CoBF involves a transmission sequence (an exchange of frames) that can be divided into two main phases: a channel sounding phase and a transmission phase.

The objective during the channel sounding phase is to make the CSI information available at the OBSS AP so that it can actively null its signal at the OBSS client. During the transmission phase, the two (or more) contributing APs agree on which clients will be served and synchronize with each then proceed with simultaneous data transmission.

Having a relatively long and complex transmission sequence for the CoBF scheme, there is a chance any of the frames within the sequence might suffer some errors that lead to a frame decoding failure. Such errors may cause a disruption and prevent participating APs from coordinating (and synchronizing) for CoBF.

Aspects of the present disclosure, however, provide various error recovery options when one or more frames of the CoBF transmission sequence are not successfully received.

By providing recovery schemes, aspects of the present disclosure may allow one or both of the participating APs to continue to use the medium during a transmit opportunity (TXOP). As such, the error recovery mechanisms proposed herein may help mitigate the impact errors have on spectral efficiency and overall system network performance.

### Example Wireless Communication Network

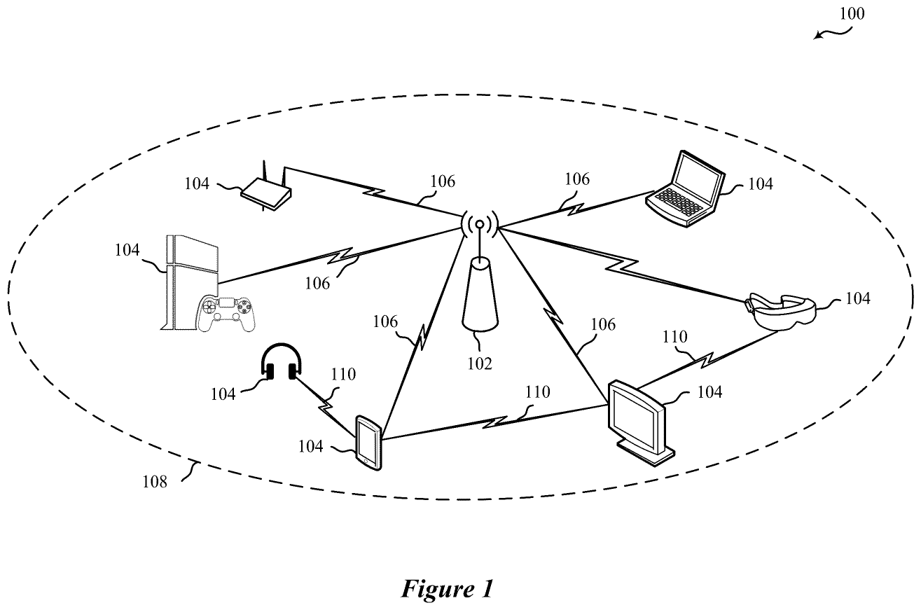

FIG. 1 shows a pictorial diagram of an example wireless communication network 100. The wireless communication network 100 includes various wireless nodes (such as AP STAs and non-AP STAs). According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network (e.g., WLAN) 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

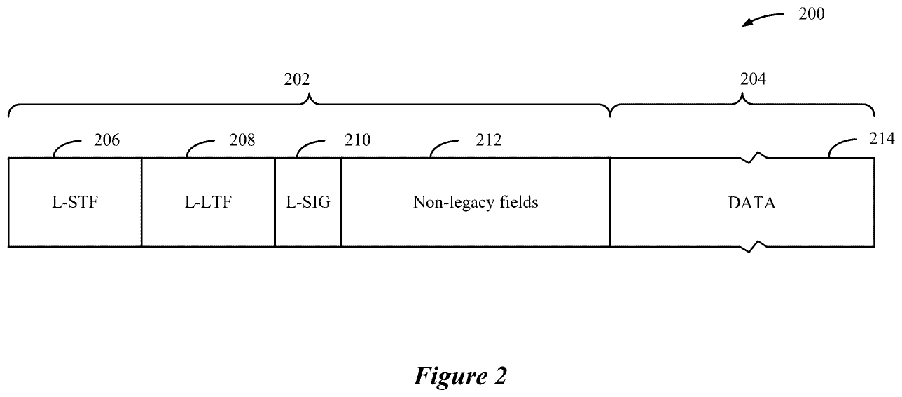

FIG. 2 shows an example protocol data unit (PDU) 200 usable for wireless communication between a wireless AP 102 and one or more wireless STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

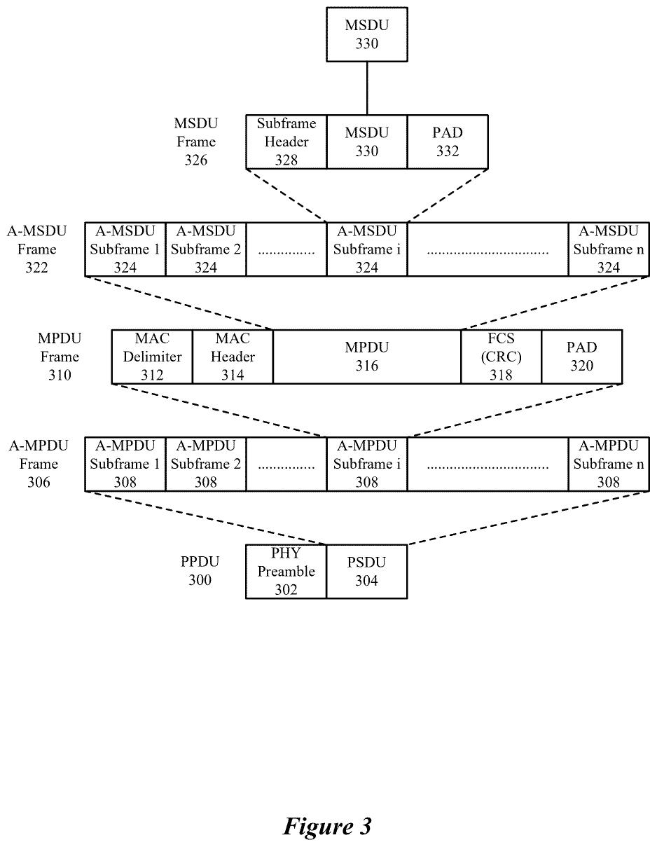

FIG. 3 shows a hierarchical format of an example PPDU usable for communications between a wireless AP 102 and one or more wireless STAs 104. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 308 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (for example, the FCS field may include a cyclic redundancy check (CRC)) and padding bits 320. The MPDU 316 may carry one or more MAC service data units (MSDUs) 330. For example, the MPDU 316 may carry an aggregated MSDU (A-MSDU) 322 including multiple A-MSDU subframes 324. Each A-MSDU subframe 324 contains a corresponding MSDU 330 preceded by a subframe header 328 and in some cases followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body 316. The MAC header 314 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 314 also includes one or more fields indicating addresses for the data encapsulated within the frame body 316. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

### Example Coordinated Communications

In downlink (DL) multi-user multiple-input-multiple-output (MU-MIMO), multiple stations may belong to one basic service set (BSS) transmitting in the DL. Other BSSs (OBSSs) within “hearing” range may defer (not transmit on the medium) in response to detecting an on-going transmission. Different BSSs in hearing range of each other may use time-divisional multiplexing (TDM) to transmit in the DL. In coordinated UL MU-MIMO, multiple BSSs carry out simultaneous UL transmissions. Un-used receive spatial dimensions at the AP may be used to null the interference from the other BSS (OBSS) transmissions. This enables a greater degree of spatial multiplexing when there are un-used spatial dimensions within the BSS. In other words, the un-used spatial dimensions may allow for concurrent OBSS transmissions in DL.

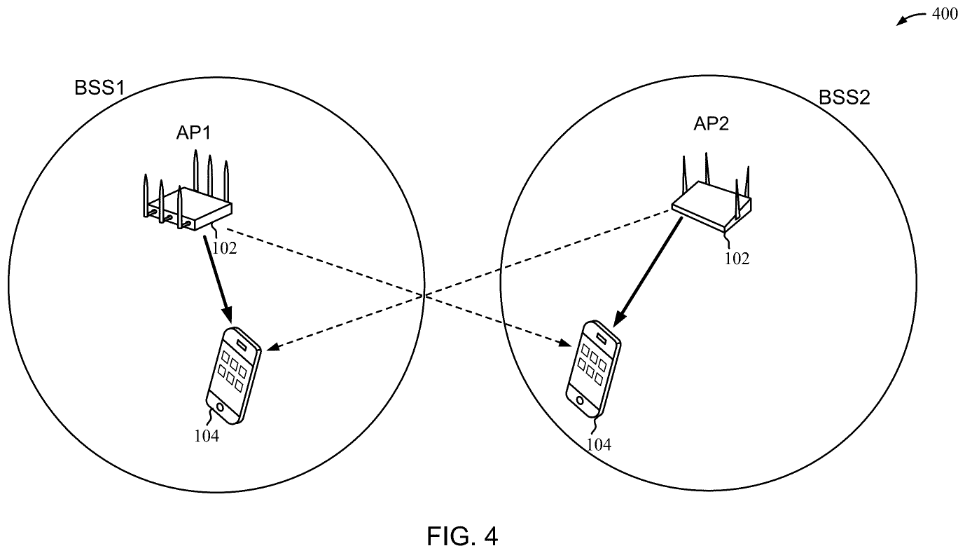

FIG. 4 illustrates a communication system 400 using coordinated DL MU-MIMO, in accordance with certain aspects of the present disclosure. As illustrated, the signal from each AP 102 is transmitted to only stations within their respective BSSs, as shown by the solid lines representing data transmissions from the AP the STAs 104 that are associated with the AP. The data transmissions from the APs cause interference to the other OBSS stations, as illustrated by the dotted lines. Un-used dimensions at the AP may be used to get rid of (e.g., null out) interference from OBSS APs.

In uplink (UL) multi-user multiple-input-multiple-output (MU-MIMO), multiple stations belonging to one BSS may transmit in the UL. Other BSSs within range may defer to an on-going transmission. Different BSSs in range of each other may use time-divisional multiplexing (TDM) to transmit in the UL. In coordinated UL MU-MIMO, multiple BSSs carry out simultaneous UL transmissions. As with DL MU-MIMO, un-used receive spatial dimensions at an AP may be used to null the interference from the other BSS (OBSS) transmissions, enabling a greater degree of spatial multiplexing and allowing for concurrent OBSS transmissions.

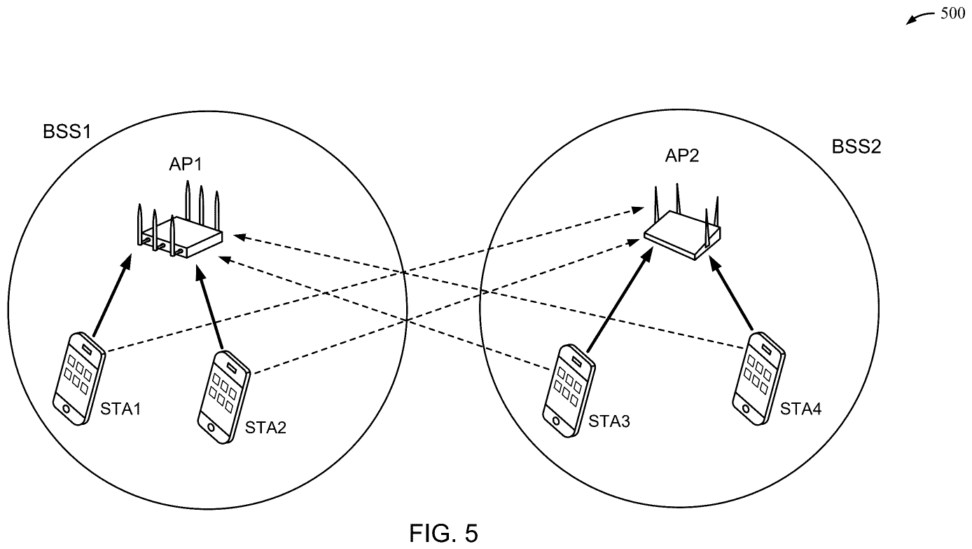

FIG. 5 illustrates an example system 500 that may utilize coordinated UL MU-MIMO. As illustrated, the signal from each STA 104 may be transmitted to only one AP 102 within their respective BSSs, as shown by the solid lines representing data transmissions to the AP the STAs are associated with. The data transmissions from the STAs cause interference to the other OBSS APs, as illustrated by the dotted lines. Un-used spatial dimensions at each AP may be used to mitigate (e.g., reduce or null out) interference from OBSS STAs.

Coordinated beamforming (CoBF) may include one or more protocols for coordinating (e.g., synchronizing) transmissions from different entities, for example, to form nulls to control interference to STAs of other OBSS, while transmitting to own (BSS) STAs.

### Example Coordinated Beamforming

As previously described, in CoBF, multiple APs may coordinate to suppress OBSS interference in the spatial domain. As such, CoBF may provide gains in an opportunistic manner, for example, when in-BSS transmissions do not fully utilize available spatial dimensions at a BSS AP.

There are various types of CoBF, such as symmetric CoBF with synchronized or asynchronized transmission and asymmetric CoBF with synchronized or asynchronized transmission. With symmetric CoBF, all APs may participate in coordinated beamforming in order to suppress their obsess interference to other victim STAs within other BSSs. With asymmetric CoBF, one device (or set of devices) may have higher or lower priority than other devices and/or may lack the capability to suppress OBSS interference.

In general, there can be multiple APs participating in CoBF. To facilitate understanding, however, example techniques will be described herein with reference to a CoBF scenario involving 2 APs. The techniques described herein may be extended to systems involving any number of APs.

The techniques described herein involve various processing for sounding and CSI feedback in CoBF. The techniques described herein may be applied to symmetric CoBF and asymmetric CoBF. As described above, in CoBF, an AP may obtain CSI from OBSS non-AP STA(s) to form nulls to the STA(s). This may involve cross-BSS sounding and CSI feedback from non-AP STA(s) to OBSS AP(s). Each AP may also obtain CSI from its own serving non-AP STA(s) to form beams to those STA(s)

In asymmetric CoBF, sounding may involve transmission of just one packet, such as a null data packet (NDP), from a secondary AP to primary recipient. In symmetric CoBF, each AP may send out an NDP to sound the intended and interfering channels. In this context, sounding generally refers to a mechanism used to gather information about the characteristics of a communication channel, in order to optimize transmission parameters to improve the overall performance of CoBF. Sounding typically involves sending specific probe frames or signals and then analyzing the responses that provide CSI feedback, to understand the channel behavior.

There are various options for sounding, for example, involving sending out NDPs to solicit CSI feedback for intended and interfering channels. In this context, an intended channel may refer to a channel between an AP and a non-AP STA served by that AP (e.g., in a same BSS), while an interfering channel may refer to a channel between an OBSS AP and a non-AP STA.

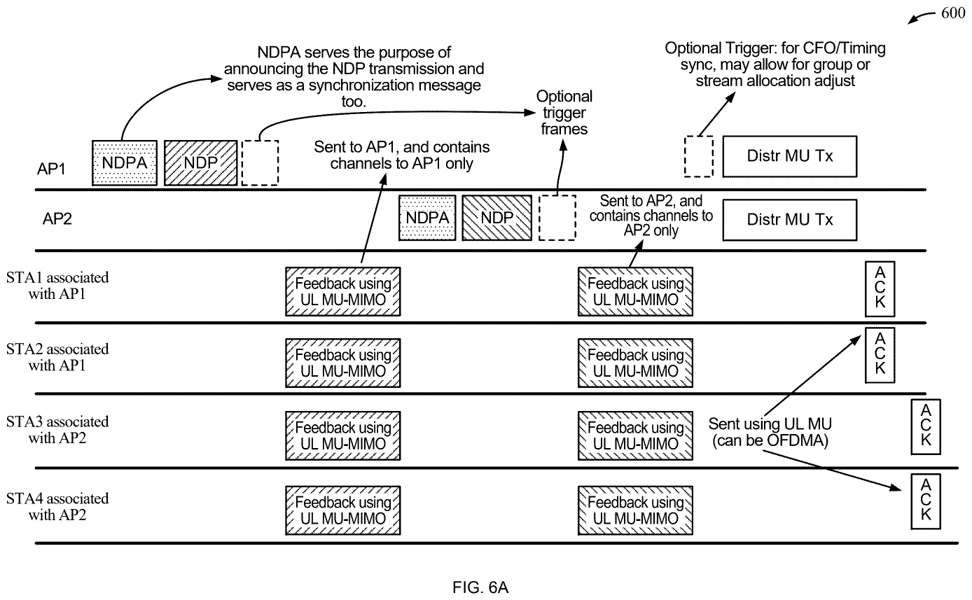

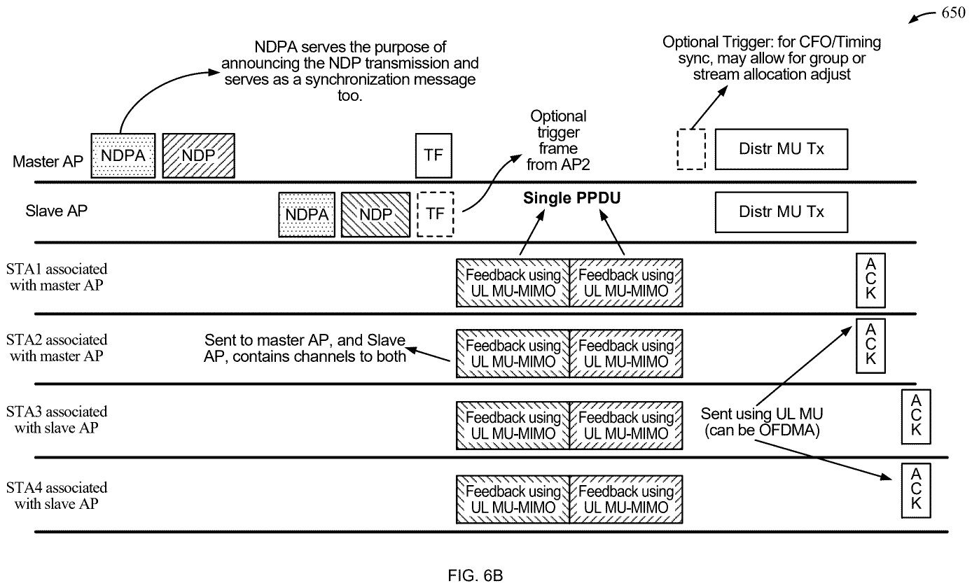

According to a first option, as illustrated in diagram 600 of FIG. 6A, each AP sends one NDP to intended and victim STAs, in a sequential manner.

In such cases, the BSS color of the AP may be included in the NDP so each STAs knows from which AP the NDP (and estimated channel) comes from. In the illustrated example, two APs (e.g., AP1 and AP2 of FIG. 5) send sequential NDPs. Based on the NDP sent from the j-th AP, each STA (e.g., the i-th STA) estimates the channel, Hᵢⱼ, channel matrix from j-th AP to the i-th STA.

As illustrated in diagram 650 of FIG. 6B, in some cases, non-AP STAs may not send CSI feedback until after all NDPs are sent and all channels are estimated.

In the illustrated example, AP1 send an NDPA and NDP, then AP2 sends an NDPA and NDP. AP1 sends a Trigger frame (TF) and at the same time AP2 may send an optional TF, triggering the STAs to send CSI feedback to both APs. To generate the CSI feedback, the non-AP STAs could use the enhanced CSI processing and small V feedback techniques described herein. The non-AP STAs could also use the large V feedback of the composite channels, provided the phase and automatic gain control (AGC) at each non-AP STAs use the same phase and AGC setting when processing all of NDP packets.

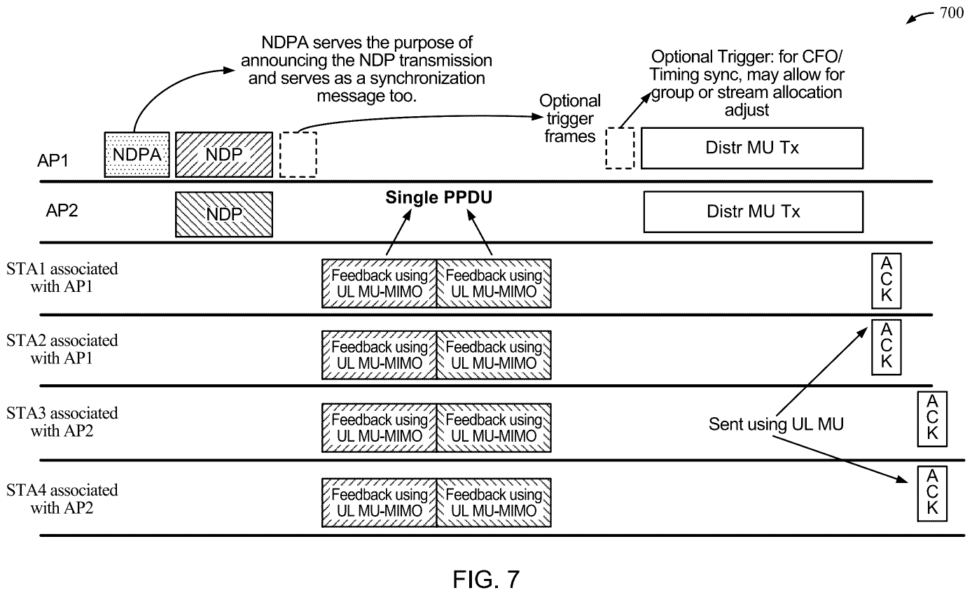

According to a second option, as illustrated in diagram 700 of FIG. 7, APs participating in CoBF may collaboratively send out a (e.g., joint) NDP to all serving STAs. The NDP may be considered a joint NDP, even though it is sent from two different APs.

In this context, a joint NDP may be one PPDU sent from both APs, with identical information (transmitted by each AP) in all fields except in a long training field (e.g., a UHR-LTF) field. In the LTF, each AP may send different streams, and the streams sent from different APs may use mutually different indices. In this manner, all APs may share a joint LTF, where the first subset of streams are sent from a 1st AP, and the second subset of streams are sent from a 2nd AP, so that the estimated channel is a composite channel where the first subset of streams are from the 1st AP and the second subset of streams are from the 2nd AP.

The joint NDP may use a group BSS color for the group of CoBF APs. The group BSS color may be sent in a prior packet, such as an NDP announcement (NDPA) frame from one of the APs (e.g., a sharing AP), before the joint NDP.

According to certain aspects of the present disclosure, to aid in CSI processing by a non-AP STA, a joint NDP may indicate which part of composite channel comes from which AP. For example, the joint NDP (or some other signaling mechanism) may signal the numbers of transmit (Tx) antennas or streams from different APs, i.e., [N_tx_1, N_tx_2, . . . ] or [N_ss_1, N_ss_2, . . . ] and the list of CoBF BSS IDs in NDPA, so that STAs know which part of composite channel comes from intended AP and which part comes from interfering AP(s). Alternatively, the joint NDP (e.g., or some other signaling mechanism) may signal the starting stream indices for different APs and the list of CoBF BSS IDs in NDPA. If the numbers of Tx antennas or streams from different APs or the start stream indices for different APs are signaled, they may be in a prior packet, e.g., NDPA, or in the joint NDP packet (e.g., in U-SIG or the common field of the UHR-SIG).

With joint sounding, each STA (the i-th STA) may estimate the composite channel matrix at from Nₐₚ APs as Hᵢ=[Hᵢ₁ Hᵢ₂ . . . H_{iN}_{ₐₚ}], where each Hij represents a channel matrix for a channel between STAi and APj. Joint NDP may have less overhead, and may help with enhanced coordinated spatial reuse (CSR) and/or joint transmission (JT) to a single or multiple STAs.

Aspects of the present disclosure also provide various options for sending CSI feedback, including cross-BSS CSI feedback (CSI-FB). In some cases, a backhaul (e.g., a light backhaul) between APs may be used for CSI exchange. In such cases, all STAs may send CSI feedbacks to their own APs and the APs may share with each other (e.g., exchanging CSI feedback) over the backhaul. In this case, UL transmissions (e.g., of CSI-FB) to own APs may be done in parallel, for example, if using coordinated UL MU-MIMO or coordinated UL OFDMA.

In some cases, if there is no backhaul, it may be assumed that coordinated UL MU-MIMO is used. In such cases, STAs may transmit to their own APs in parallel, then the STAs may transmit to OBSS in APs in parallel. In other cases, coordinated UL MU-MIMO may not be assumed, though this may mean both APs do not receive simultaneously and, hence, may have additional latency for each STA to feedback to all the APs one at a time.

In some cases, coordinated UL MU-MIMO may involve CoBF, with un-utilized spatial dimensions of the AP used to perform receive (Rx) nulling of OBSS UL transmissions.

Aspects of the present disclosure provide various options that may be applied in both point-to-point channel CSI processing and feedback and composite channel CSI processing and feedback.

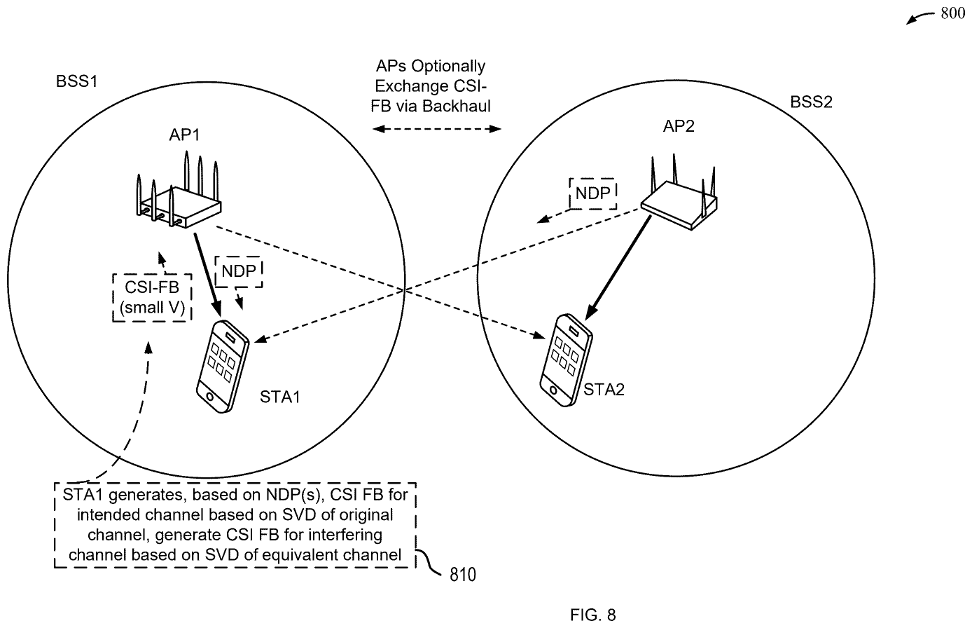

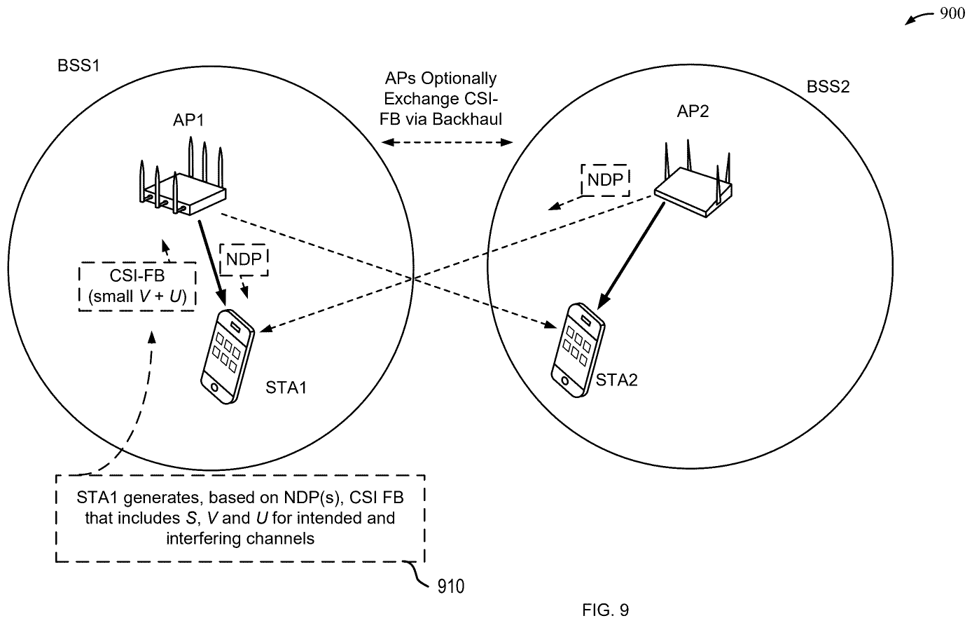

In this context, point-to-point channel feedback generally refers to the CSI feedback of a channel between two STAs, such as an AP and a non-AP STA (e.g., with a channel matrix Hᵢⱼ for APj and STAi). As will be described below with reference to FIG. 8 and FIG. 9, for point-to-point channel feedback, there are also various sub-options with different types of CSI processing (to generate the CSI feedback) and different types of content fed back (as CSI feedback).

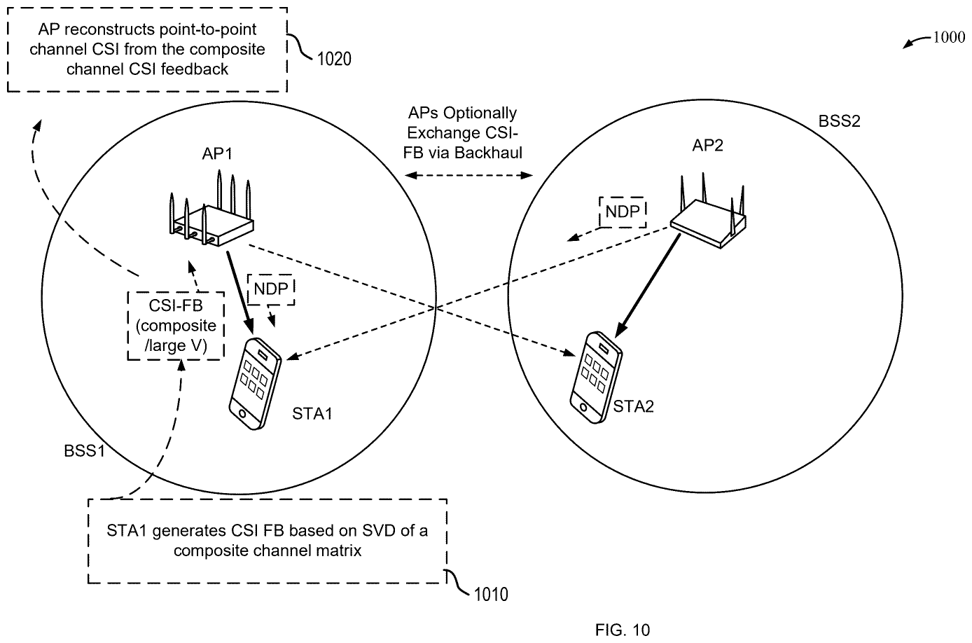

A composite channel may be either point to multi-point (e.g., from one AP to multiple non-AP STAs) or multi-point to single point (e.g., from multiple APs to a single STA). In this context, composite channel feedback generally refers to the CSI feedback of a composite channel, such as the channel from multiple APs (e.g., an in-BSS and OBSS AP) to a single STA (Hᵢ). As will be described below with reference to FIG. 10, aspects of the present disclosure provide techniques for a non-AP STA to generate composite channel CSI feedback and for an AP to reconstruct point-to-point channel CSI from the composite channel CSI feedback.

Point-to-point Channel CSI processing and feedback may be performed as follows. An N_{rx,i}×N_{tx,j} channel matrix from a j-th AP (APj) to an i-th STA (STAi) may be denoted as Hᵢⱼ where N_{rx,i} is the number of receive antennas of APj and N_{tx,j} is the number of transmit antennas from APj (and N_{rx,i}≤N_{tx,j}).

Based on the channel estimation of a packet (e.g., an NDP) from APj, STAi may obtain the channel matrix Hᵢⱼ and perform a singular value decomposition (SVD) on Hᵢⱼ to obtain:

$${H}_{ij} = {U}_{ij} \cdot {S}_{ij} \cdot {V}_{ij}^{′} ,$$

where Uᵢⱼ is an N_{rx,i}×N_{rx,i} (left semi-unitary or) unitary matrix, Sᵢⱼ is an N_{rx,j}×N_{rx,i} diagonal matrix with the singular values of the channel Hᵢⱼ, and Vᵢ is an N_{tx,j}×N_{rx,j} (right) semi-unitary (or unitary) matrix.

In some cases, CSI feedback may be what is referred to as small V feedback. With small V feedback, STAi feeds back Sᵢⱼ and Vᵢⱼ of requested rank N_{fb,i}, i.e., S_{fb,ij}=Sᵢⱼ(1:N_{fb,i},1:N_{fb,i}) and V_{fb,ij}=Vᵢⱼ(:,1:N_{fb,i}), where the requested rank may be signaled to the STA in a prior packet, e.g., NDPA. The notation of A(i:j, k:l) represents a submatrix of A, by selecting from the i-th to j-th rows and from the k-th to 1-th columns. The notation “:” in a submatrix A(:, k:l) represents a submatrix of A, by selecting all rows and from the k-th to 1-th columns. Likewise, the notation “:” in a submatrix A(i:j, :) represents a submatrix of A, by selecting from the i-th to j-th rows and all columns. In this manner, an AP may request CSI feedback (of certain matrices) to be of a certain rank (or number of columns). For example, an SVD may produce 4 Eigen channels, but the AP may only request a rank of 2 or 3 in a CSI feedback request.

In the case of small V feedback, the reconstructed channel

$${rH}_{ij} = {S}_{fb , ij} \cdot {V}_{fb , ij}^{′}$$

corresponds to the Eigen channels using the

$${U}_{nfb , ij}^{′}$$

receiver (which is not fed back), where U_{nfb,ij}=Uᵢⱼ(:, 1:N_{fb,i}). In this case, the full channel Hᵢⱼ may not be reconstructed, which may result in less than optimal CoBF.

According to one of the sub-options presented herein, however, STAi may use a CSI processing technique for the small V feedback of the intended and interfering channels based on the same receiver.

Referring to FIG. 8, an example of this first sub-option for point-to-point channel CSI processing and feedback is shown. The example assumes AP1 (BSS1) and AP2 (BSS2) transmit NDP(s) for sounding. As noted at 810, STA1 generates, based on the NDP(s), CSI FB for intended channel (between AP1 and STA1) based on SVD of original channel and generates CSI FB for interfering channel (between AP2 and STA1) based on an SVD of equivalent channel.

As illustrated, in some cases, STA1 may provide this (enhanced small V) CSI-FB to AP1. In some cases, STA1 may also provide this CSI-FB directly to AP2. In other cases, AP1 and AP2 may exchange CSI-FB (e.g., if a backhaul exists). For example, AP1 may transmit the CSI-FB for the interfering channel (between AP2 and STA1) to AP2 via a light backhaul. While not shown, STA2 may also generate CSI-FB for its intended channel (between AP2 and STA2) and interfering channel (between AP1 and STA2) and provide this CSI-FB to at least its AP (AP2).

This enhanced CSI processing for small V feedback according to this first sub-option may be described as follows, assuming the i-th AP is the serving AP of the i-th STA so that Hᵢⱼ is an intended channel and all other Hᵢⱼ where j≠i are interfering channels.

For intended channel Hᵢᵢ, STAi may feed back S_{fb,ii}=Sᵢᵢ(1:N_{fb,i},1:N_{fb,i}) and V_{fb,ii}=Vᵢᵢ(:, 1:N_{fb,i}) where N_{fb,i}=N_{ss,i}, where N_{ss,i} is the number of streams for the i-th STA that the i-AP intended to send in the CoBFed transmission, assuming using the eigen receiver

$${U}_{ss , ii}^{′}$$

(not fed back) where U_{ss,ii}=Uᵢᵢ(:, 1:N_{ss,i}).

For interfering channel Hᵢⱼ where ≠i, the equivalent channel assuming the Eigen receiver at the i-th STA is

$${U}_{ss , ii}^{′}$$

so that the equivalent channel from the j-th AP to the i-th STA after this Eigne receiver processing becomes

$${U}_{ss , ii}^{′} {H}_{ij} .$$

For the CSI FB for the interfering channel, STAi may perform SVD on the equivalent channel

$${U}_{ss , ii}^{′} {H}_{ij}$$

to obtain:

$${U}_{ss , ii}^{′} {H}_{ij} = {U}_{ss , ij} \cdot {S}_{ss , ij} \cdot {V}_{ss , ij}^{′} ,$$

where U_{ss,ij} is an N_{ss,i}×N_{ss,i} unitary matrix, S_{ss,ij} is an N_{ss,i}×N_{ss,i} diagonal matrix with the singular values of the equivalent channel

$${U}_{ss , ii}^{′} {H}_{ij} ,$$

and V_{ss,i}, is an N_{tx,j}×N_{ss,i} semi-unitary matrix. Feedback S_{fb,ij}=S_{ss,ij}(1:N_{fb,i},1:N_{fb,i}) and V_{fb,ij}=V_{ss,ij}(:, 1:N_{fb,i}), where N_{fb,i}=N_{ss,i}.

A distinction between the enhanced small V feedback according to this first sub-option and typical V feedback is that the enhanced feedback (for the interfering channels) is based on the SVD of the equivalent channel

$${U}_{ss , ii}^{′} {H}_{ij}$$

instead of the SVD of the original channel Hᵢⱼ. In this way, the same receiver

$${U}_{ss , ii}^{′}$$

is assumed for intended and interfering channels. In this example, it is assumed that the Eigen receiver

$${U}_{ss , ii}^{′}$$

is used to generate both the CSI FB for the intended channel Hᵢⱼ and the CSI FB for the interfering equivalent channel

$${U}_{ss , ii}^{′} {H}_{ij} .$$

A more general case in the enhanced feedback is to use a same linear receiver Gᵢ to generate both the CSI FB for the intended equivalent channel GᵢHᵢᵢ and the CSI FB for the interfering equivalent channel GᵢHᵢⱼ.

According to another of the sub-options presented herein, however, STAi may feedback U, S, and V from the SVD of the point-to-point channel. For example, STAi may feed back Uᵢⱼ, Sᵢⱼ and Vᵢⱼ of a requested rank N_{fb,i}, i.e., U_{nfb,ij} (e.g., fed back in this case), S_{fb,ij} and V_{fb,ij}.

Referring to FIG. 9, an example of this second sub-option for point-to-point channel CSI processing and feedback is shown. As noted at 910, in this case, STA1 generates CSI FB that includes S, V and U for intended and interfering channels. The STA may then provide the CSI-FB (which may be referred to as small V plus U) to at least AP1.

In this case, at APj, the reconstructed channel

$${rH}_{ij} = {U}_{nfb , ij} \cdot {S}_{fb , ij} \cdot {V}_{fb , ij}^{′}$$

is the original channel in full rank feedback, and is an approximation of the original channel (with dominant Eigen modes) in partial rank feedback. The rank of transmission to the i-th STA intended in the CoBFed transmission is N_{ss,i}, where, in general, N_{ss,i}≤N_{fb,i}≤N_{rx,j}.

Referring to FIG. 10, an example of composite channel CSI processing and feedback is shown. As noted at 1010, in this case, STA1 generates CSI FB based on SVD of a composite channel matrix. In this context, a composite channel matrix generally refers to a channel matrix that represents the channel from all APs to the same non-AP STA. The composite channel matrix may be obtained by combining (stacking) all the point-to-point channel matrices, where each is from one AP to the non-AP STA, into a big matrix or could be obtained from channel estimate when processing a single packet (e.g., joint NDP) sent from both the first and second wireless nodes using a joint LTF.

Composite channel CSI processing and feedback may be performed as follows. The composite channel matrix at the i-th STA from Nₐₚ APs may be denoted as Hᵢ=[Hᵢ₁ Hᵢ₂ . . . H_{iN}_{ₐₚ}]. The i-th STA may perform SVD on Hᵢ to obtain:

$${H}_{i} = {U}_{i} \cdot {S}_{i} \cdot {V}_{i}^{′} ,$$

where Uᵢ is an N_{rx,i}×N_{rx,i} unitary matrix, Sᵢ is an N_{rx,i}×N_{rx,i} diagonal matrix with the singular values of the channel, and Vᵢ is an (N_{tx,1}+N_{tx,2}+ . . . +N_{tx,N}_{ₐₚ})×N_{rx,i} semi-unitary matrix.

In what may be referred to as large V feedback, the i-th STA may feed back Sᵢ and Vᵢ of requested rank N_{fb,i}, i.e., S_{fb,i}=Sᵢ(1:N_{fb,i},1:N_{fb,i}) and V_{fb,i}=Vᵢ(:, 1:N_{fb,i}).

At an AP, the reconstructed composite channel

$${rH}_{i} = {S}_{fb , i} \cdot {V}_{fb , i}^{′}$$

corresponds to the eigen channels using the

$${U}_{nfb , i}^{′}$$

receiver (not fed back), where U_{nfb,i}=Uᵢ(:, 1:N_{fb,i}). In may be noted that

$${rH}_{i} = {U}_{nfb , i}^{′} {H}_{i} = [ {U}_{nfb , i}^{′} \cdot {H}_{i 1} , {U}_{nfb , i}^{′} \cdot {H}_{i 2} , … , {U}_{nfb , i}^{′} \cdot {H}_{ij} , … ] = [ {rH}_{i 1} , {rH}_{i 2} , … , {rH}_{ij} , … ] ,$$

$$where {rH}_{ij} = {U}_{nfb , i}^{′} \cdot {H}_{ij}$$

is the equivalent channel from the j-th AP to the i-th STA assuming using the

$${U}_{nfb , i}^{′}$$

receiver (same receiver assumed for intended and interfering channels). Thus, different subsets of columns in the reconstruction composite channel rHᵢ correspond to different reconstruction channels rHᵢⱼ.

Reconstruction of point-to-point channel CSI from the composite channel CSI feedback may be as follows. In this case,

$${rH}_{ij} = {U}_{nfb , i}^{′} \cdot {H}_{ij}$$

is the equivalent channel from the j-th AP to the i-th STA assuming using the

$${U}_{nfb , i}^{′}$$

receiver and it is taken from columns corresponding to the Tx antennas from the j-th AP in the reconstruction composite channel rHᵢ.

SVD may be performed on the reconstructed channel matrix

$${rH}_{ij} = {rU}_{ij} \cdot {rS}_{ij} \cdot {rV}_{ij}^{′} ,$$

where rUᵢⱼ is an N_{fb,i}×N_{fb,i} unitary matrix, rSᵢⱼ is an N_{fb,i}×N_{fb,i} diagonal matrix with the singular values of the reconstructed channel rHᵢⱼ, and rVᵢⱼ is an N_{tx,j}×N_{fb,i} semi-unitary matrix. rSᵢⱼ and rVᵢⱼ is the point-to-point channel CSI in the form of small V feedback.

As described herein, the content and quantity of CSI feedback provided by different non-AP STAs may vary.

For example, in some cases, a non-AP STA is able to estimate the intended channel and the interfering channel(s) but is not able to process them jointly. This may be the case, for example, in the scenario of sequential sounding NDP and CSI feedback may happen after each sounding NDP. One STA may have to send CSI feedback of the interfering channel (from an interfering AP) before that STA could estimate the intended channel from own AP. In some cases, the STA could use small V feedback (e.g., without the enhancements proposed herein) or small U plus V feedback of each point-to-point channel. In this case, CSI from each non-AP STA may be sent to different APs directly, or sent to its serving AP and then relayed to interfering AP(s) through backhaul.

In some cases, a non-AP STA may be able to estimate the intended channel and the interfering channel(s) and process them jointly. This may be the scenario of sequential sounding NDP (and CSI feedback happens after receiving sounding NDPs from all APs or at least after the STA could estimate the intended channel from own AP) or the scenario of joint NDP when signaling indicates which part of composite channel comes from which AP. In such cases, the non-AP STA may send small V feedback (e.g., without the enhancements proposed herein) or small U plus V feedback of each point-to-point channel.

Alternatively, the non-AP STA could perform the enhanced CSI processing for small V feedback described above. In this case, the CSI feedback is still point-to-point channel CSI. Further, CSI from each non-AP STA may be sent to different APs directly, or sent to its serving AP and then relayed to interfering AP(s) through backhaul, as noted above.

In some cases, the non-AP STA may only be able to estimate the composite channel. This may be the scenario of joint NDP when there is no signaling to indicate which part of composite channel comes from which AP. In this case, the non-AP STA may send the large V (composite) feedback to its own AP and interfering AP(s). As an alternative, if there is a backhaul between APs, the non-AP STA may send the large V feedback to its own (serving) AP. In this case, its serving AP could reconstruct the point-to-point channel CSI of the interfering channel(s) and send the CSI feedback of each interfering channel to each of the corresponding interfering AP(s).

### Example Enhancements for Sounding and CSI Feedback for CoBF

Aspects of the present disclosure may provide various error recovery options when one or more frames of the CoBF transmission sequence are no successfully received.

CoBF involves a transmission sequence that can be divided into two main phases: a channel sounding phase and a transmission phase.

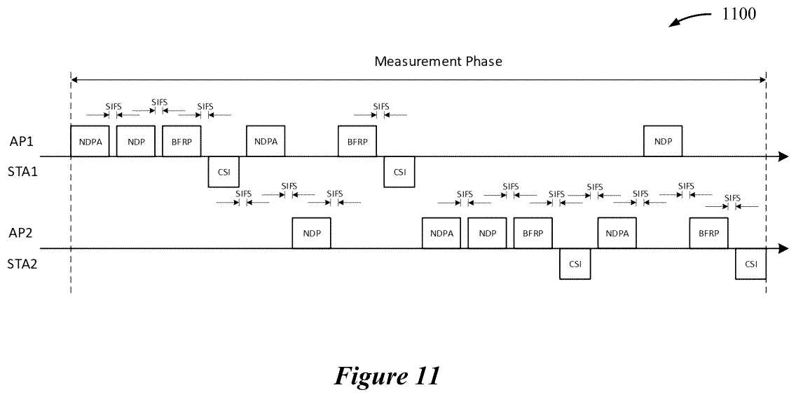

FIG. 11 shows an example diagram 1100 for a CoBF sounding (or measurement) phase. As noted above, the objective during the channel sounding phase is to make the OBSS clients' CSI information available at an AP so that it can actively null its signal at the OBSS client(s).

Channel sounding is a collaborative process done by two (or more) APs to collect CSI info between each AP and the OBSS clients. The general procedures of CoBF channel sounding follow the same concept as conventional (so called “legacy”) in-BSS channel sounding using the NDPA-NDP-BFRP-CSI frame sequence.

The example shown in FIG. 11 is for sequential sounding. As illustrated, sounding is first done with respect to the STA's associated AP (e.g., AP1) by transmitting an NDP and getting CSI info in response to a BFRP frame. Sounding is next done for the OBSS AP where the associated AP (AP1) sends an NDPA on behalf of the OBSS AP. The OBSS AP (AP2) sends an NDP followed by a BFRP frame sent by the associated AP on behalf of the OBSS AP. Finally, the Client (In-BSS STA1) reports back its measured CSI.

As illustrated, this whole process will be repeated for all APs participating in the channel sounding process (e.g., with the roles of AP1 and AP2 reversed).

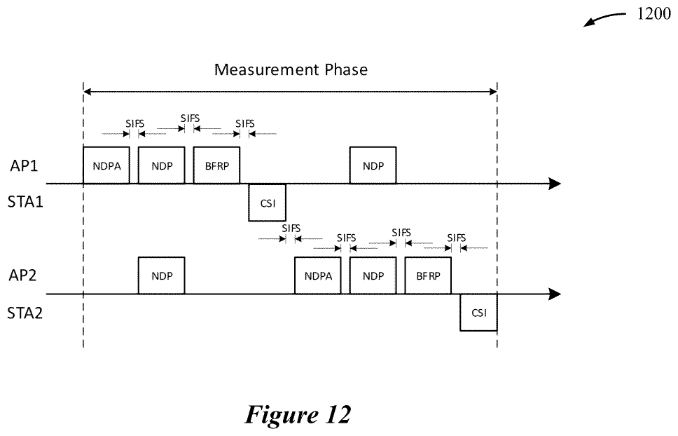

FIG. 12 shows an example diagram 1200 for joint sounding, which has the general aim to perform the sounding process in a more efficient way by doing CSI estimation to the associated AP as well as the OBSS AP simultaneously.

FIG. 12 shows a similar sounding sequence to that of sequential sounding (shown in FIG. 11) but with the following differences. As illustrated, NDP frames are sent jointly by both APs at the same time where, for instance, CSI estimation to the two APs can be done using a separate set of LTFs (with different streams transmitted from each AP). Joint sounding may save up to 3 frame exchanges per AP (when compared to sequential sounding), which can help reduce the overhead of the sounding sequence.

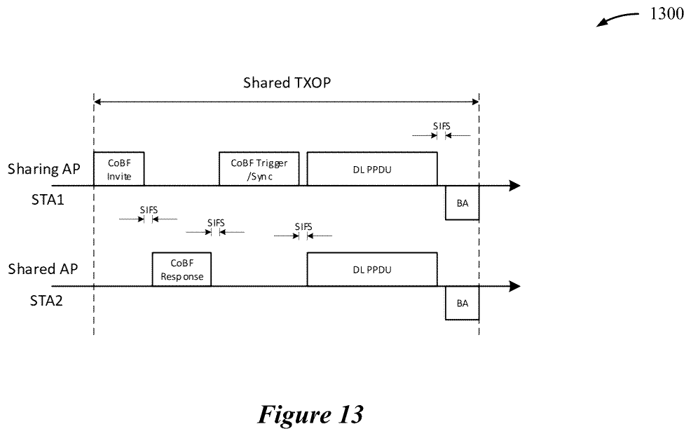

FIG. 13 shows an example diagram 1300 for a CoBF transmission phase. During transmission phase, the two APs need to agree on which clients will be served and whether each AP can null its Tx signal at the other AP's client or not.

This agreement may be achieved by means of the following 3-way handshaking sequence. First, an invitation (CoBF Invite) is transmitted by the sharing AP, in which the Sharing AP shares which client it will serve with the shared AP. The Shared AP may send a response to the invitation (CoBF Response), in which the Shared AP shares which client it will serve with the sharing AP.

The sharing AP may then send a trigger frame (CoBF Trigger/Sync), in which the Sharing AP shares certain information that may be needed for the Shared and Sharing APs to transmit a common preamble. This trigger frame itself may be used as a synchronization reference for frequency and time, to synchronize the subsequent downlink (DL) PPDU sent by each AP.

CoBF may be used with certain advanced features, such as enhanced Multi-link Single-Radio (eMLSR) Operation. eMLSR is a feature that allows a device to utilize multiple radio links simultaneously, even with only a single active radio, by dynamically switching between them to improve network performance and throughput, while maintaining cost-efficiency compared to fully multi-radio systems.

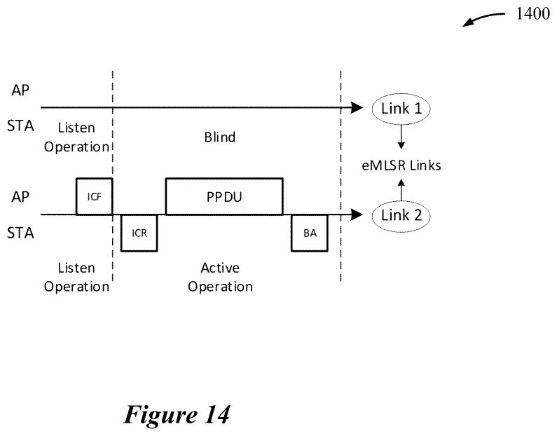

FIG. 14 shows an example diagram 1400 for enhanced multilink single radio (eMLSR) clients capable of supporting multiple links (Link 1 and Link 2).

An eMLSR STA needs to activate the communication link before it becomes ready for any frame exchanges.

To do so, as illustrated in FIG. 14, a frame exchange involving an initial control frame (ICF) and an initial control frame response (ICR) may need to take place first between the AP and the eMLSR STA to let it activate the link. Sufficient padding may be provided in the ICF to give enough time for the eMLSR STA for link activation.

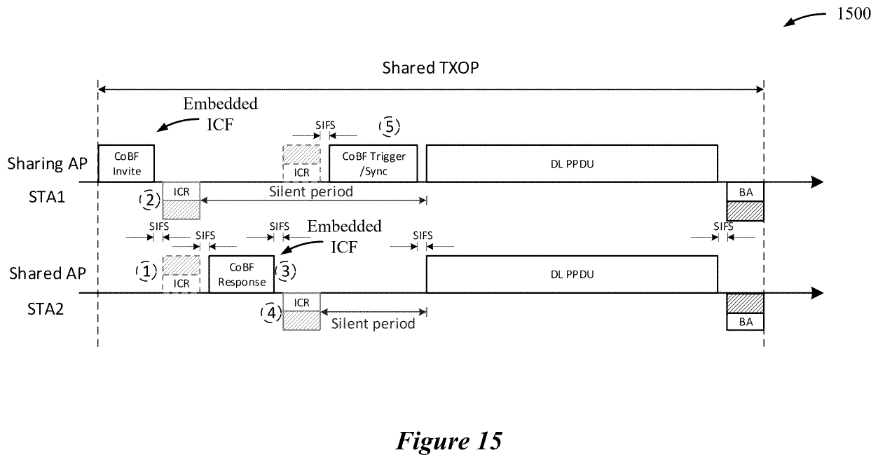

FIG. 15 shows a diagram 1500 for an example CoBF transmission sequence that is updated to accommodate eMLSR STAs, by including ICF/ICR frame exchanges.

For example, the CoBF Invite may be updated to include an embedded ICF frame that solicits an ICR from the scheduled STA by the sharing AP (STA1). As such, the CoBF Invite may request the STA to activate the communication link and provide the needed padding for link activation (and may optionally solicit an ICR response from the shared AP as well, labeled frame (1)).

The ICR from STA1, labeled frame (2), confirms the communication link activation and availability for further frame exchanges. In this example, the CoBF Response from the shared AP, labeled frame (3), also includes an embedded ICF frame that solicits an ICR, labeled frame (4), from the scheduled STA by the shared AP (STA2).

This ICF embedded in the CoBF Response may, thus, request the STA (STA2) to activate the communication link and provide the needed padding for link activation (and may optionally solicit an ICR response from the sharing AP as well). The ICR from STA2 confirms the communication link activation and availability for further frame exchanges. The CoBF Trigger/Sync frame, labeled frame (5), may be similar to that of the basic sequence discussed above with reference to FIG. 13.

As noted above, having a relatively long and complex transmission sequence for the CoBF scheme, particularly when supporting eMLSR, there is a chance any of the frames within the sequence might suffer some errors that lead to a frame decoding failure. Such errors may cause a disruption and prevent participating APs from coordinating (and synchronizing) for CoBF.

Aspects of the present disclosure, however, provide various error recovery options when one or more frames of the CoBF transmission sequence are not successfully received. The particular actions taken for error recovery may depend, at least in part, on which frame is not detected.

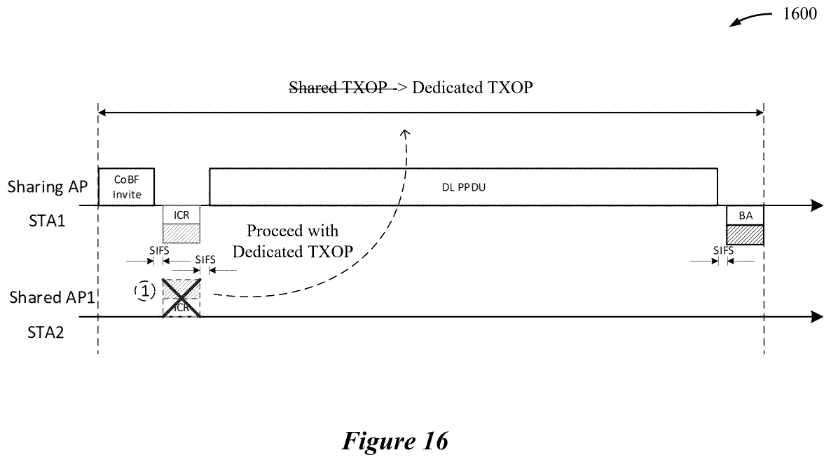

For example, FIG. 16 shows an example diagram 1600 that depicts error recovery when the shared AP response, labeled frame (1), is missed. As indicated (by the X), when the shared AP response is missing, the sharing AP may proceed with dedicated use of the TXOP.

The shared AP response may be missed, for example, due to other OBSS transmissions heard by the shared AP but hidden to the sharing AP. According to certain aspects, as an alternative to, or prior to, proceeding with a dedicated TXOP, the sharing AP may attempt one or more additional exchanges. In some cases, this additional attempt may only be made if energy is detected in resource units (RUs) allocated for the shared AP response (e.g., indicating a corrupted response but not missing).

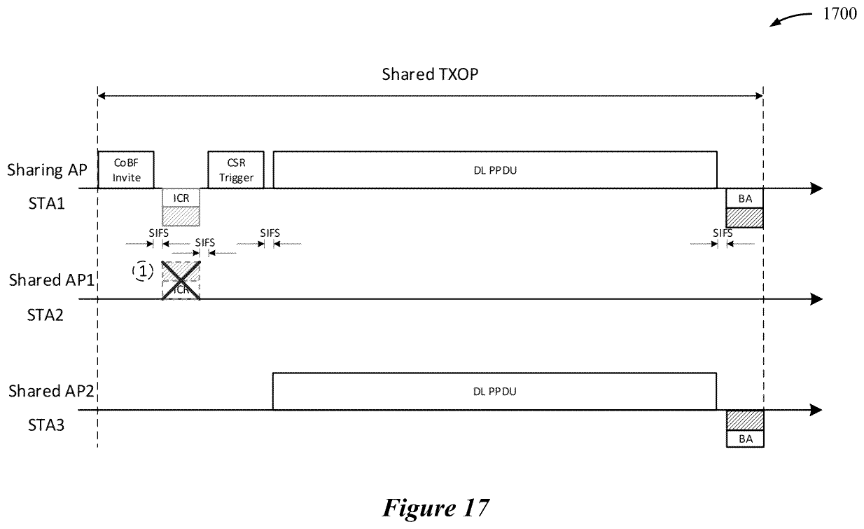

FIG. 17 shows an example diagram 1700 for another option of error recovery when the shared AP response, labeled frame (1), is missed. As illustrated, according to this option, when the shared AP response is not detected, the sharing AP may switch rom CoBF to a coordinated spatial reuse (CSR) scheme or another coordinated communication scheme. This approach may be used when the sharing AP has a list of other potential CSR shared APs (e.g., Shared AP2) that can use the shared TXOP.

In this scenario, Shared AP1 will be excluded from the APs polled for CSR operation. Further, if possible, the sharing AP can send another CoBF Invitation (not shown) to another candidate shared AP.

While the example in FIG. 17 depicts a switch from CoBF to CSR, this approach may be generalized to various other types of TXOP sharing or APs coordination schemes. For example, a similar approach may be used to switch from a CoBF scheme to a coordinated time division multiple access (C-TDMA) scheme as an option for error recovery (when a failure scenario is detected).

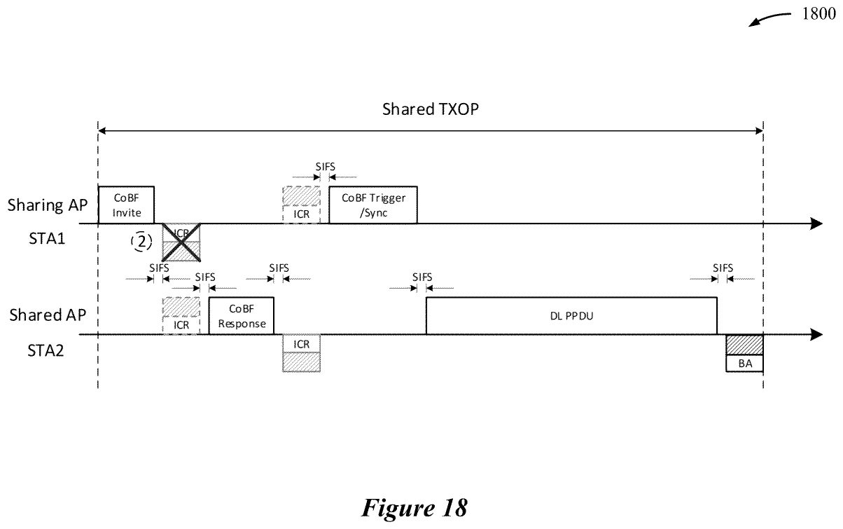

FIG. 18 shows an example diagram 1800 for error recovery when the response from the STA scheduled by the sharing AP (STA1), labeled frame (2), is missed. When the sharing AP's scheduled STA (STA2's) response is missing, then no transmissions can take place within the sharing AP's BSS for that client.

One option in this case is to give STA1 a second try and resend the CoBF Invite soliciting responses from STA1 and shared AP. This approach may make sense when the non-zero energy is detected but the ICR decoding fails.

Another option is to try another STA in the second attempt. Another option is to still send the CoBF Trigger to let the shared AP do its transmission (while the sharing AP does not transmit). In this case, the shared AP may be given an indication in the CoBF Trigger to let the shared AP know that it does not have to do the beam nulling, which may be similar to coordinated time division multiple access (C-TDMA).

The sharing AP may take various actions when it realizes it cannot proceed with CoBF with the specified STA and wants to terminate the sequence. For example, the sharing AP may send a negative ICR in response to CoBF Response, ignore the CoBF Response (and not respond with an ICR), or send a negative ICR and indicate switching to a C-TDMA-like operation.

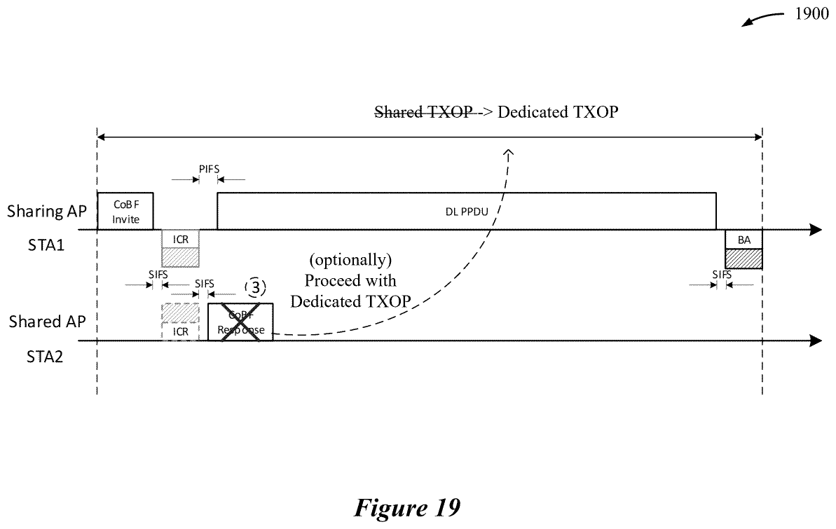

FIG. 19 shows an example diagram 1900 for error recovery when the CoBF Response from the shared AP, labeled frame (3), is missed.

If no energy detected for the shared AP CoBF Response, a Point Coordination Function Interframe Space (PIFS) recovery may be performed and the sharing AP may optionally proceed with a dedicated TXOP. Another option is for the sharing AP to proceed with CoBF or CSR (or any other multi-AP coordination scheme) with another AP (e.g., as described with reference to FIG. 17).

In case energy is detected, but the Shared AP CoBF response failed to decode, the sharing AP may not respond with an ICR. As an alternative, the sharing AP may respond with a negative ICR and then send another CoBF Invite to the same shared AP. This approach may be used, for example, in the case of successful reception of an ICR from shared AP as response to the CoBF Invite.

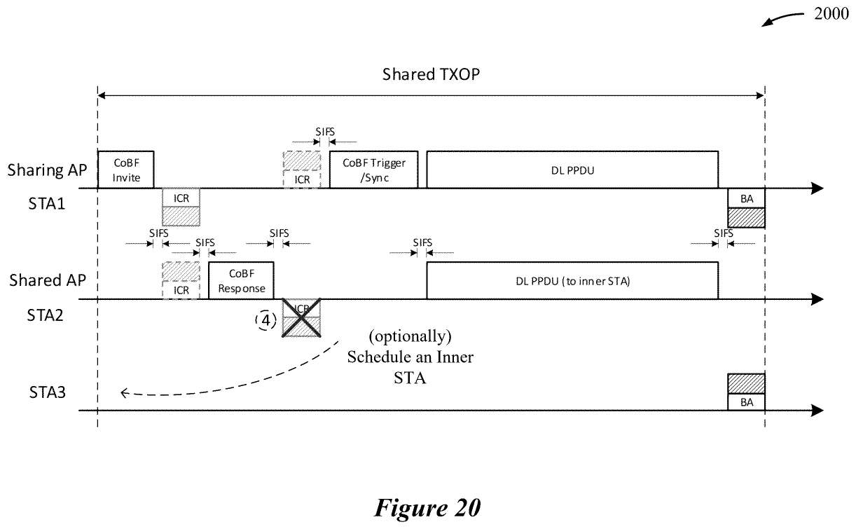

FIG. 20 shows an example diagram 2000 for error recovery when the Shared AP Scheduled STA Response (from STA2), labeled frame (4), is missed.

When the shared AP's scheduled STA response is missing, then there is typically no way for the shared AP to notify the sharing AP to change the transmission mode.

One option proposed herein is for the shared AP to schedule what may be referred to as an inner STA (STA3 in this example) that will only be minimally affected by the sharing AP's transmission. In this context, an inner STA refers to a STA that may be close to its associated AP and has relatively good immunity against interference from other APs. In this scenario, beam nulling at the sharing AP's STA may still be applied to this shared AP transmission. Further, the inner STA (STA3) may not be in an operation mode that requires ICF/ICR before data transmission.

As shown in FIG. 20, the inner STA (STA3) may send a block acknowledgment (BA), to the shared AP's DL PPDU, over specific RUs. This RU assignment may be communicated to the STA3 prior to the TXOP.

If the BA RU assignment cannot be communicated to STA3 before the TXOP, then a delayed ACK policy may be enforced where no BA is sent back SIFS after the DL PPDU then an explicit BA request (BAR) frame should be sent later after the TXOP soliciting the BA frame.

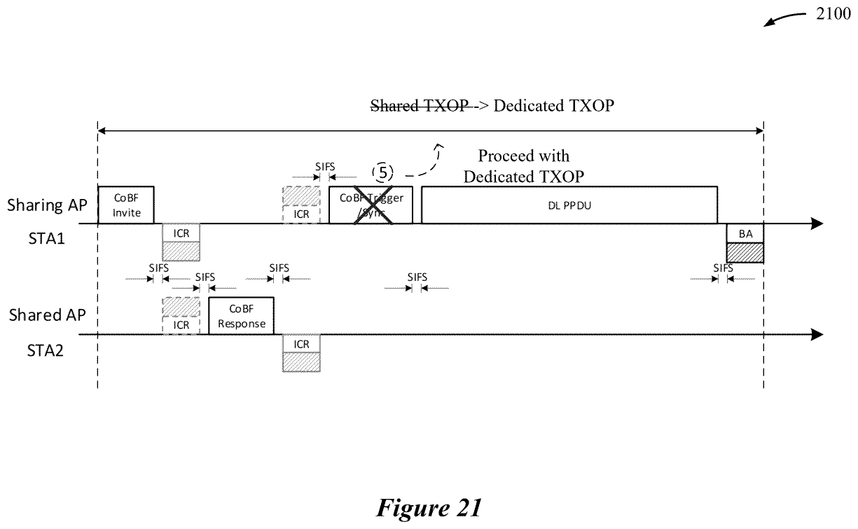

FIG. 21 shows an example diagram 2100 for error recovery when the CoBF trigger frame from the Sharing AP, labeled frame (5), is missed.

When the CoBF Trigger frame is not successfully decoded, the shared AP may be unable to generate a synchronized CoBF PPDU in response. In such a case, as illustrated, the sharing AP may proceed in the TXOP with dedicated transmission by the sharing AP.

This scenario may occur, for example, if other STAs get out of sync and interfere on the CoBF Trigger frame. Another possible option, in such a scenario, is for the shared AP to transmit a beamformed downlink PPDU, for example, without time or frequency synchronization with the sharing AP.

### Example Methods

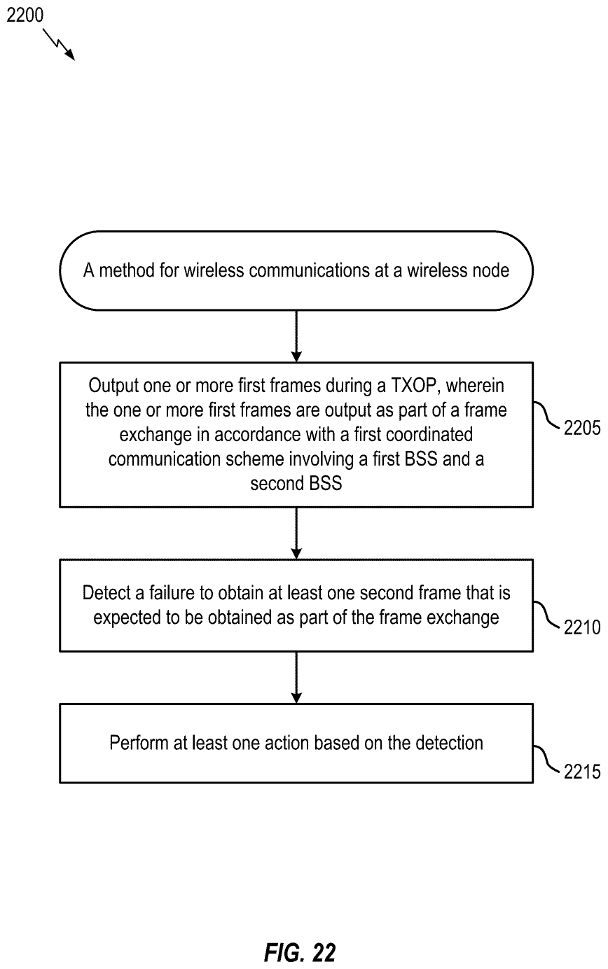

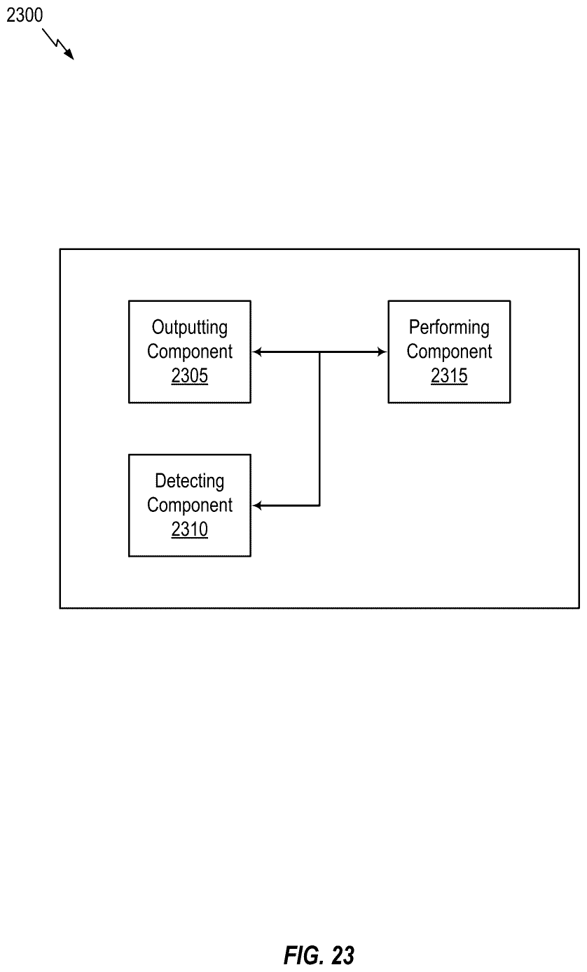

FIG. 22 shows a flowchart illustrating an example process 2200 performable by or at a first wireless node. The operations of the process 2200 may be implemented by a wireless STA, or its components as described herein, and/or wireless AP, or its components as described herein. For example, the process 2200 may be performed by a wireless communication device, such as the wireless communication device 2300 described with reference to FIG. 23, operating as or within a wireless STA or operating as or within a wireless AP. In some examples, the process 2200 may be performed by a wireless STA such as one of the STAs 104 described with reference to FIG. 1. In some examples, the process 2200 may be performed by a wireless AP such as one of the APs 102 described with reference to FIG. 1.

In some examples, in block 2205, the first wireless node may output one or more first frames during a transmit opportunity (TXOP), wherein the one or more first frames are output as part of a frame exchange in accordance with a first coordinated communication scheme involving a first basic service set (BSS) and a second BSS. In some cases, the operations of this step refer to, or may be performed by, an outputting component as described with reference to FIG. 23.

In some examples, in block 2210, the first wireless node may detect a failure to obtain at least one second frame that is expected to be obtained as part of the frame exchange. In some cases, the operations of this step refer to, or may be performed by, a detecting component as described with reference to FIG. 23.

In some examples, in block 2215, the first wireless node may perform at least one action based on the detection. In some cases, the operations of this step refer to, or may be performed by, a performing component as described with reference to FIG. 23.

In some aspects, the first wireless node is associated with the first BSS; the one or more first frames comprise an initial control frame (ICF); and the at least one second frame is expected to be obtained from at least one of a second wireless node associated with the first BSS or a third wireless node associated with the second BSS.

In some aspects, the at least one second frame comprises at least one of a first initial control response (ICR) that is expected to be obtained from the second wireless node or a second ICR that is expected to be obtained from the third wireless node.

In some aspects, the at least one second frame comprises the second ICR; and the at least one action comprises at least one of: proceeding without sharing the TXOP with the third wireless node; or switching to a second coordinated communication scheme.

In some aspects, the at least one second frame comprises the second ICR; and the at least one action comprises outputting another ICF to solicit an ICR from the third wireless node or a third wireless node associated with a third BSS.

In some aspects, the at least one second frame comprises the first ICR; and the at least one action comprises at least one of: outputting another ICF to solicit an ICR from the second wireless node or a third wireless node associated with the first BSS; outputting a trigger frame to allow the third wireless node to participate during the TXOP; or one or more actions designed to terminate the frame exchange.

In some aspects, the ICF is conveyed in an invitation to participate in the first coordinated communication scheme; and the at least one second frame comprises a response to the invitation.

In some aspects, the at least one action comprises at least one of: proceeding without sharing the TXOP with the third wireless node, outputting another invitation, or switching to a second coordinated communication scheme.

In some aspects, the first wireless node is associated with the second BSS; the exchange includes an invitation to participate in the first coordinated communication scheme obtained from a second wireless node associated with the first BSS; the one or more first frames comprise an initial control frame (ICF) outputted in a response to the invitation; and the at least one second frame comprises an initial control response (ICR) that is expected to be obtained from a third wireless node associated with the second BSS in response to the ICF.

In some aspects, the at least one action comprises scheduling communications with a third wireless node during the TXOP after failing to obtain the ICR from the third wireless node, wherein the third wireless node is associated with the second BSS.

In some aspects, the first wireless node is associated with the second BSS; the exchange includes an invitation to participate in the first coordinated communication scheme obtained from a second wireless node associated with the first BSS; the one or more first frames comprise a response to the invitation; and the at least one second frame comprises a trigger frame that is expected to be obtained from the second wireless node after outputting the response.

In some aspects, the at least one action comprises: refraining from communicating for a remainder of the TXOP after detecting the failure; or outputting a beamformed transmission during the TXOP.

Note that FIG. 22 is just one example of a process, and other processes including fewer, additional, or alternative steps are possible consistent with this disclosure.

### Example Device

FIG. 23 shows a block diagram of an example wireless communication device 2300. In some examples, the wireless communication device 2300 is configured to perform the process 2200 described with reference to FIG. 22. The wireless communication device 2300 may include one or more chips, SoCs, chipsets, packages, components or devices that individually or collectively constitute or include a processing system. The processing system may interface with other components of the wireless communication device 2300, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 2300 may transmit the information output from the chip. In such an example, the second interface may refer to an interface between the processing system of the chip and a reception component, such that the device 2300 may receive information that is passed to the processing system. In some such examples, the first interface also may obtain information, such as from the transmission component, and the second interface also may output information, such as to the reception component.

The processing system of the wireless communication device 2300 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 2300 can be configurable or configured for use in a STA, such as the STA 104 described with reference to FIG. 1. In some other examples, the wireless communication device 2300 can be a STA that includes such a processing system and other components including multiple antennas. In some examples, the wireless communication device 2300 can be configurable or configured for use in an AP, such as the AP 102 described with reference to FIG. 1. In some other examples, the wireless communication device 2300 can be an AP that includes such a processing system and other components including multiple antennas. The wireless communication device 2300 is capable of transmitting and receiving wireless communications in the form of, for example, wireless packets. For example, the wireless communication device 2300 can be configurable or configured to transmit and receive packets in the form of physical layer PPDUs and MPDUs conforming to one or more of the IEEE 802.11 family of wireless communication protocol standards. In some other examples, the wireless communication device 2300 can be configurable or configured to transmit and receive signals and communications conforming to one or more 3GPP specifications including those for 5G NR or 6G. In some examples, the wireless communication device 2300 also includes or can be coupled with one or more application processors which may be further coupled with one or more other memories. In some examples, the wireless communication device 2300 further includes a user interface (UI) (such as a touchscreen or keypad) and a display, which may be integrated with the UI to form a touchscreen display that is coupled with the processing system. In some examples, the wireless communication device 2300 may further include one or more sensors such as, for example, one or more inertial sensors, accelerometers, temperature sensors, pressure sensors, or altitude sensors, that are coupled with the processing system. In some examples, the wireless communication device 2300 further includes at least one external network interface coupled with the processing system that enables communication with a core network or backhaul network that enables the wireless communication device 2300 to gain access to external networks including the Internet.

The wireless communication device 2300 includes outputting component 2305, detecting component 2310, and performing component 2315. Portions of one or more of the components 2305, 2310, and 2315 may be implemented at least in part in hardware or firmware. For example one or more of the components 2305, 2310, and 2315 may be implemented at least in part by a processor or a modem. In some examples, portions of one or more of the components 2305, 2310, and 2315 may be implemented at least in part by a processor and software in the form of processor-executable code stored in a memory.

### Example Clauses

Implementation examples are described in the following numbered clauses.

Clause 1: A method for wireless communication at a first wireless node, including: outputting one or more first frames during a transmit opportunity (TXOP), wherein the one or more first frames are output as part of a frame exchange in accordance with a first coordinated communication scheme involving a first basic service set (BSS) and a second BSS; detecting a failure to obtain at least one second frame that is expected to be obtained as part of the frame exchange; and performing at least one action based on the detection.

Clause 2: The method of Clause 1, where the first wireless node is associated with the first BSS; the one or more first frames include an initial control frame (ICF); and the at least one second frame is expected to be obtained from at least one of a second wireless node associated with the first BSS or a third wireless node associated with the second BSS.

Clause 3: The method of Clause 2, where the at least one second frame includes at least one of a first initial control response (ICR) that is expected to be obtained from the second wireless node or a second ICR that is expected to be obtained from the third wireless node.

Clause 4: The method of Clause 3, where the at least one second frame includes the second ICR; and the at least one action includes at least one of: proceeding without sharing the TXOP with the third wireless node; or switching to a second coordinated communication scheme.

Clause 5: The method of Clause 3, where the at least one second frame includes the second ICR; and the at least one action includes outputting another ICF to solicit an ICR from the third wireless node or a third wireless node associated with a third BSS.

Clause 6: The method of Clause 3, where the at least one second frame includes the first ICR; and the at least one action includes at least one of: outputting another ICF to solicit an ICR from the second wireless node or a third wireless node associated with the first BSS; outputting a trigger frame to allow the third wireless node to participate during the TXOP; or one or more actions designed to terminate the frame exchange.

Clause 7: The method of Clause 2, where the ICF is conveyed in an invitation to participate in the first coordinated communication scheme; and the at least one second frame includes a response to the invitation.

Clause 8: The method of Clause 7, where the at least one action includes at least one of: proceeding without sharing the TXOP with the third wireless node, outputting another invitation, or switching to a second coordinated communication scheme.

Clause 9: The method any one of Clauses 1-8, where the first wireless node is associated with the second BSS; the exchange includes an invitation to participate in the first coordinated communication scheme obtained from a second wireless node associated with the first BSS; the one or more first frames include an initial control frame (ICF) outputted in a response to the invitation; and the at least one second frame includes an initial control response (ICR) that is expected to be obtained from a third wireless node associated with the second BSS in response to the ICF.

Clause 10: The method of Clause 9, where the at least one action includes scheduling communications with a third wireless node during the TXOP after failing to obtain the ICR from the third wireless node, wherein the third wireless node is associated with the second BSS.

Clause 11: The method any one of Clauses 1-10, where the first wireless node is associated with the second BSS; the exchange includes an invitation to participate in the first coordinated communication scheme obtained from a second wireless node associated with the first BSS; the one or more first frames include a response to the invitation; and the at least one second frame includes a trigger frame that is expected to be obtained from the second wireless node after outputting the response.

Clause 12: The method of Clause 11, where the at least one action includes: refraining from communicating for a remainder of the TXOP after detecting the failure; or outputting a beamformed transmission during the TXOP.

Clause 13: An apparatus, including: at least one memory including instructions; and at least one processor configured to execute the instructions to cause the apparatus to perform a method in accordance with any combination of Clauses 1-12.

Clause 14: An apparatus, including means for performing a method in accordance with any combination of Clauses 1-12.

Clause 15: A non-transitory computer-readable medium including executable instructions that, when executed by at least one processor of an apparatus, cause the apparatus to perform a method in accordance with any combination of Clauses 1-12.

Clause 16: A computer program product embodied on a computer-readable storage medium including code for performing a method in accordance with any combination of Clauses 1-12.

Clause 17: A wireless node (e.g., an access point), including: at least one transceiver, at least one memory including instructions; and at least one processor configured to execute the instructions to cause the apparatus to perform a method in accordance with any combination of Clauses 1-12, wherein the at least one transceiver is configured to transmit the one or more first frames.

### ADDITIONAL CONSIDERATIONS

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

Means for outputting, means for performing, means for detecting, means for proceeding, means for switching, means for scheduling, and means for refraining may comprise one or more processors, such as one or more processors described above (e.g., with reference to FIG. 23).

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by an AP STA may also (or instead) be performed by a non-AP STA. Similarly, operations performed by a non-AP STA may also (or instead) be performed by an AP STA.

Further, while the present disclosure may describe certain types of communications between different types of wireless nodes (e.g., between an AP STA and a non-AP STA), the same or similar types of communications may occur between same types of wireless nodes (e.g., between AP STAs or between non-AP STAs, in a peer-to-peer scenario). Further, communications may occur in reverse order than described.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable sub combination. As such, although features may be described above as acting in particular combinations, and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communication, comprising:
at least one transceiver;
at least one memory comprising instructions; and
one or more processors configured to execute the instructions to cause the apparatus to:
transmit, via the at least one transceiver, one or more first frames during a transmit opportunity (TXOP), wherein the one or more first frames are transmitted as part of a frame exchange in accordance with a first coordinated communication scheme involving a first basic service set (BSS) and a second BSS;
detect a failure to receive at least one second frame that is expected to be received, via the at least one transceiver, as part of the frame exchange; and
perform at least one action based on the detection.

2. The apparatus of claim 1, wherein:
the apparatus is associated with the first BSS;
the one or more first frames comprise an initial control frame (ICF); and
the at least one second frame is expected to be received from at least one of a first wireless node associated with the first BSS or a second wireless node associated with the second BSS.

3. The apparatus of claim 2, wherein:
the at least one second frame comprises at least one of a first initial control response (ICR) that is expected to be received from the first wireless node or a second ICR that is expected to be received from the second wireless node.

4. The apparatus of claim 3, wherein:
the at least one second frame comprises the second ICR; and
the at least one action comprises at least one of:
proceeding without sharing the TXOP with the second wireless node; or
switching to a second coordinated communication scheme.

5. The apparatus of claim 3, wherein:
the at least one second frame comprises the second ICR; and
the at least one action comprises transmitting, via the at least one transceiver, another ICF to solicit an ICR from the second wireless node or a third wireless node associated with a third BSS.

6. The apparatus of claim 3, wherein:
the at least one second frame comprises the first ICR; and
the at least one action comprises at least one of:
transmitting, via the at least one transceiver, another ICF to solicit an ICR from the first wireless node or a third wireless node associated with the first BSS;
transmitting, via the at least one transceiver, a trigger frame to allow the second wireless node to participate during the TXOP; or
one or more actions designed to terminate the frame exchange.

7. The apparatus of claim 2, wherein:
the one or more first frames comprise an invitation to participate in the first coordinated communication scheme;
the ICF is conveyed via the invitation; and
the at least one second frame comprises a response to the invitation.

8. The apparatus of claim 7, wherein the at least one action comprises at least one of:
proceeding without sharing the TXOP with the second wireless node,
transmitting, via the at least one transceiver, another invitation, or
switching to a second coordinated communication scheme.

9. The apparatus of claim 1, wherein:
the apparatus is associated with the second BSS;
the exchange includes an invitation to participate in the first coordinated communication scheme received from a first wireless node associated with the first BSS;
the one or more first frames comprise an initial control frame (ICF) transmitted in a response to the invitation; and
the at least one second frame comprises an initial control response (ICR) that is expected to be received from a second wireless node associated with the second BSS in response to the ICF.

10. The apparatus of claim 9, wherein the at least one action comprises scheduling communications with a third wireless node during the TXOP after failing to receive the ICR from the second wireless node, wherein the third wireless node is associated with the second BSS.

11. The apparatus of claim 1, wherein:
the apparatus is associated with the second BSS;
the exchange includes an invitation to participate in the first coordinated communication scheme received from a first wireless node associated with the first BSS;
the one or more first frames comprise a response to the invitation; and
the at least one second frame comprises a trigger frame that is expected to be received from the first wireless node after transmitting the response.

12. The apparatus of claim 11, wherein the at least one action comprises:
refraining from communicating for a remainder of the TXOP after detecting the failure; or
transmitting, via the at least one transceiver, a beamformed transmission during the TXOP.

13. The apparatus of claim 1, wherein the apparatus is configured to operate as an access point.

14. A method for wireless communication by a first wireless node, comprising:
transmitting one or more first frames during a transmit opportunity (TXOP), wherein the one or more first frames are transmit as part of a frame exchange in accordance with a first coordinated communication scheme involving a first basic service set (BSS) and a second BSS;
detecting a failure to receive at least one second frame that is expected to be received as part of the frame exchange; and
performing at least one action based on the detection.

15. The method of claim 14, wherein:
the first wireless node is associated with the first BSS;
the one or more first frames comprise an initial control frame (ICF); and
the at least one second frame is expected to be received from at least one of a second wireless node associated with the first BSS or a third wireless node associated with the second BSS.

16. The method of claim 15, wherein:
the at least one second frame comprises at least one of a first initial control response (ICR) that is expected to be received from the second wireless node or a second ICR that is expected to be received from the third wireless node.

17. The method of claim 16, wherein:
the at least one second frame comprises the second ICR; and
the at least one action comprises at least one of:
proceeding without sharing the TXOP with the third wireless node; or
switching to a second coordinated communication scheme.

18. The method of claim 16, wherein:
the at least one second frame comprises the second ICR; and
the at least one action comprises transmitting another ICF to solicit an ICR from the third wireless node or a third wireless node associated with a third BSS.

19. The method of claim 16, wherein:
the at least one second frame comprises the first ICR; and
the at least one action comprises at least one of:
transmitting another ICF to solicit an ICR from the second wireless node or a third wireless node associated with the first BSS;
transmitting a trigger frame to allow the third wireless node to participate during the TXOP; or
one or more actions designed to terminate the frame exchange.

20. The method of claim 15, wherein:
the one or more first frames comprise an invitation to participate in the first coordinated communication scheme;
the ICF is conveyed via the invitation; and
the at least one second frame comprises a response to the invitation.
